(19) United States
(12) Patent Application Publication
(10) Pub. No.: US 2024/0030554 A1
(43) Pub. Date: Jan. 25, 2024

(54) SEPARATOR AND ELECTROCHEMICAL APPARATUS AND ELECTRONIC APPARATUS INCLUDING SUCH SEPARATOR

(71) Applicant: Ningde Amperex Technology Limited, Ningde (CN)

(72) Inventors: Xiaohe FAN, Ningde (CN); Zengbin WEI, Ningde (CN)

(73) Assignee: Ningde Amperex Technology Limited, Ningde (CN)

(21) Appl. No.: 18/477,780

(22) Filed: Sep. 29, 2023

Related U.S. Application Data
(63) Continuation of application No. PCT/CN21/84647, filed on Mar. 31, 2021.

(51) Int. Cl. H01M 50/457; H01M 50/426; H01M 50/42; H01M 50/417; H01M 50/443; H01M 50/489; H01M 50/434; H01M 10/42

(52) U.S. Cl. CPC H01M 50/457; H01M 50/426; H01M 50/42; H01M 50/417; H01M 50/443; H01M 50/489; H01M 50/434; H01M 10/4235

(57) ABSTRACT

A separator includes a separator substrate, and a first coating and a second coating respectively disposed on two surfaces of the separator substrate, where the first coating includes polymer secondary particles, and the secondary particles have a melting point of 130° C. to 150° C. The first coating in the separator has good adhesion and resistance to electrolyte swelling, and the secondary particles have many internal voids, which facilitates the penetration of the electrolyte, thus improving electrolyte penetration into the first coating and enhancing the low-temperature performance of the electrochemical apparatus.

### CROSS REFERENCE TO THE RELATED APPLICATIONS

This application is a continuation under 35 U.S.C. § 120 of international patent application PCT/CN2021/084647 filed on Mar. 31, 2021, the entire content of which is incorporated herein by reference.

### TECHNICAL FIELD

This application relates to the electrochemical field, and specifically relates to a separator and an electrochemical apparatus and electronic apparatus including such separator.

### BACKGROUND

Lithium-ion batteries have advantages such as high specific energy, high operating voltage, low self-discharge rate, small size, and low weight, and therefore are widely used in various fields such as energy storage, portable electronic apparatus, and electric vehicles.

As lithium-ion batteries rapidly advance in applications such as electric vehicles and other fields, their low-temperature performance struggles to adapt to low-temperature environments, making their limitations increasingly apparent. In low-temperature conditions, the performance of lithium-ion batteries, such as effective discharge capacity, significantly decreases, which restricts the application of lithium-ion batteries. Therefore, there is an urgent need to enhance the low-temperature performance of lithium-ion batteries.

### SUMMARY

A purpose of this application is to provide a separator and an electrochemical apparatus and electronic apparatus including such separator, to improve low-temperature performance of lithium-ion batteries. Specific technical solutions are as follows:

A first aspect of this application provides a separator including a separator substrate, and a first coating and a second coating respectively provided on two surfaces of the separator substrate;
where the first coating includes polymer secondary particles, the secondary particles having a melting point of 130° C. to 150° C.

It should be noted that in the following of this application, lithium-ion batteries are used as an example of an electrochemical apparatus to explain this application, but the electrochemical apparatus of this application is not limited to lithium-ion batteries.

The first coating and the second coating in this application may be respectively provided on two surfaces of the separator substrate. The polymer secondary particles in the first coating may be formed by aggregation of the primary particles, so that the secondary particles have many internal voids, and the electrolyte can more easily penetrate into these voids, thereby facilitating improvement of electrolyte penetration into the first coating.

The polymer secondary particles of this application have a melting point of 130° C. to 150° C. Without being limited to any theory, under a condition that the secondary particles have an excessively high melting point, for example, higher than 150° C., it is not conducive to improving the adhesion of the first coating; and under a condition that the secondary particles have an excessively low melting point, for example, lower than 130° C., the polymer is prone to over-swelling or even dissolving in the electrolyte, which leads to a decrease in the adhesion of the first coating and deteriorates kinetic performance of the lithium-ion battery. With the melting point of the secondary particles of this application controlled within the above range, the first coating with a low degree of swelling and good adhesion can be obtained.

The second coating of this application includes a polymer, and the polymer may be selected from a high molecular polymer.

In an embodiment of this application, the primary particles forming the secondary particles have a Dv50 of 50 nm and 1000 nm, and the primary particles may be polymer particles. Without being limited to any theory, under a condition that the primary particles have an excessively small Dv50, for example, less than 50 nm, the secondary particles formed have fewer internal voids, and the electrolyte is less likely to penetrate into the voids, which is not conducive to improving electrolyte penetration into the first coating; and under a condition that the primary particles have an excessively large Dv50, the primary particles are less prone to agglomeration to form secondary particles, which affects electrolyte penetration into the first coating. With the Dv50 of the primary particles of this application controlled within the above range, the first coating with good penetration and adhesion can be obtained.

In an embodiment of this application, the secondary particles have a Dv50 of 10 μm to 30 μm. Without being limited to any theory, under a condition that the secondary particles have an excessively small Dv50, for example, less than 10 μm, the secondary particles are more prone to agglomeration, which affects the kinetic performance of the lithium-ion battery; and under a condition that the secondary particles have an excessively large Dv50, for example, greater than 30 μm, adhesion of the secondary particles is likely to decrease, which is unfavorable to the improvement of the adhesion of the first coating and affects the energy density of the lithium-ion battery. With the Dv50 of the secondary particles of this application controlled within the above range, the first coating with good adhesion can be obtained.

In an embodiment of this application, the secondary particles have a sphericity of 0.7 to 1. Without being limited to any theory, under a condition that the secondary particles have an excessively low sphericity, for example, less than 0.7, the secondary particles are more likely to cover the surface of the separator substrate, hindering lithium ion transmission and affecting the kinetic performance of the lithium-ion battery. With the sphericity of the secondary particles of this application controlled within the above range, the first coating with good adhesion can be obtained.

In an embodiment of this application, the secondary particles have a crystallinity of 38% to 46%. Without being limited to any theory, under a condition that the secondary particles have an excessively low crystallinity, for example, lower than 38%, swelling of the secondary particles increases, and voids in the separator substrate are prone to be blocked, hindering lithium ion transmission and affecting the kinetic performance of the lithium-ion battery; and under a condition that the secondary particles have excessively high crystallinity, for example, higher than 46%, the secondary particles have a relatively high melting point, and therefore adhesion of the secondary particles decreases, which is not conducive to improvement of the adhesion of the first coating. With the crystallinity of the secondary particles of this application controlled within the above range, the first coating with good adhesion can be obtained.

In an embodiment of this application, the first coating has a coating weight of 0.4 g/m² to 1.0 g/m², and the second coating has a coating weight of 0.1 g/m² to 1 g/m². Without being limited to any theory, under a condition that the first coating or the second coating has an excessively small coating weight, interfacial adhesion is insufficient and the coating adhesion decreases; and under a condition that the first coating or the second coating has an excessively high coating weight, the relative percentage of an electrode active material in the lithium-ion battery decreases, affecting the energy density of the lithium-ion battery. With the coating weight of the first coating and/or the second coating including the secondary particles of this application controlled within the above range, the interfacial adhesion can be improved between the separator and the electrode plate, and the relative percentage of the electrode active material in the lithium-ion battery can be increased, thus improving the energy density of the lithium-ion battery.

In an embodiment of this application, the first coating has a thickness of 5 μm to 20 μm; the second coating has a thickness of 0.2 μm to 4 μm. Without being limited to any theory, under a condition that the first coating or the second coating has an excessively small thickness, the interfacial adhesion is insufficient and the coating adhesion decreases; and under a condition that the first coating or the second coating has an excessively large thickness, the relative percentage of an electrode active material in the lithium-ion battery decreases, affecting the energy density of the lithium-ion battery. With the thickness of the first coating and/or the second coating of the secondary particles of this application controlled within the above range, there is a good interfacial adhesion between the separator and the electrode plate, and the relative percentage of the electrode active material in the lithium-ion battery can be increased, thereby improving the energy density of the lithium-ion battery.

In an embodiment of this application, to improve the adhesion between the secondary particles and achieve better adhesion effect between the secondary particles and the separator substrate, an auxiliary binder may be contained in the first coating, so as to play the role of auxiliary adhesion, and a mass of the auxiliary binder accounts for 5 wt % to 15 wt % of a total mass of the first coating, and accordingly, the secondary particles account for 85 wt % to of the total mass of the first coating. The percentage of the auxiliary binder should not be excessively low or excessively high. Under a condition that the percentage is excessively low, the adhesion ability between the secondary particles is affected, and under a condition that the percentage is excessively high, the percentage of the secondary particles decreases and therefore the adhesion of the first coating is affected.

The secondary particles of this application may include at least one of homopolymers or copolymers of vinylidene fluoride, hexafluoropropylene, ethylene, propylene, vinyl chloride, chloropropylene, acrylic acid, acrylate, styrene, butadiene, and acrylonitrile.

In this application, there is no particular limitation on the type of high molecular polymer in the second coating, as long as the purpose of this application can be realized. For example, the high molecular polymer may be selected from at least one of homopolymers or copolymers of methyl acrylate, ethyl acrylate, butyl acrylate, methyl methacrylate, ethyl methacrylate, butyl methacrylate, ethylene, styrene, chlorostyrene, fluorostyrene, methylstyrene, acrylic acid, and methacrylic acid, methacrylonitrile, and maleic acid.

In an embodiment, the second coating includes a high molecular polymer with a core-shell structure, a main component in the core may be a polymer, and the polymer may be a homopolymer polymerized with one polymeric monomer or a copolymer polymerized with two or more polymeric monomers. Specifically, the core of the high molecular polymer with a core-shell structure is selected from at least one of homopolymers or copolymers of ethyl acrylate, butyl acrylate, ethyl methacrylate, styrene, chlorostyrene, fluorostyrene, methyl styrene, acrylic acid, methacrylic acid, and maleic acid.

The shell of the high molecular polymer binder with a core-shell structure may alternatively be a homopolymer of one polymeric monomer or a copolymer of two or more polymeric monomers, the polymeric monomer being selected from acrylate, an aromatic monovinyl compound, or a nitrile vinyl compound. Specifically, the core of the high molecular polymer with a core-shell structure is selected from at least one of homopolymers or copolymers of methyl acrylate, ethyl acrylate, butyl acrylate, methyl methacrylate, ethyl methacrylate, butyl methacrylate, ethylene, chlorostyrene, fluorostyrene, methylstyrene, acrylonitrile, and methacrylonitrile.

In an embodiment of this application, the second coating includes a high molecular polymer with a non-core-shell structure, the high molecular polymer with a non-core-shell structure being selected from at least one of homopolymers or copolymers of acrylic acid, acrylate, butadiene, styrene, acrylonitrile, ethylene, chlorostyrene, fluorostyrene, or propylene.

In an embodiment of this application, the second coating may further include a thickener, an auxiliary binder, and a wetting agent. The thickener serves to increase the stability of the slurry and to prevent the slurry from settling. This application has no special limitations on the thickener, as long as the purpose of the invention of this application can be achieved. For example, the thickener can be sodium carboxymethyl cellulose. The auxiliary binder plays the role of auxiliary bonding to further improve the adhesion of the second coating. There is no special limitation on the auxiliary binder in this application, as long as the purpose of this application can be achieved. For example, the auxiliary binder may include at least one of homopolymers or copolymers of ethyl acrylate, butyl acrylate, ethyl methacrylate, styrene, chlorostyrene, fluorostyrene, methyl styrene, acrylic acid, methacrylic acid, maleic acid, acrylonitrile, or butadiene. The function of the wetting agent is to reduce the surface energy of the slurry and prevent coating leakage. There is no special limitation on the wetting agent in this application, as long as the purpose of this application can be achieved. For example, the wetting agent may include at least one of dimethylsiloxane, poly(ethylene oxide), vinyl oxyethylene alkyl phenol ether, poly(vinyl oxyethylene) aliphatic alcohol ether, poly(vinyl oxyethylene) poly(oxyethylene) poly(ethylene) poly(propylene) block copolymer, or dioctyl sodium sulfosuccinate.

In an embodiment of this application, based on a total mass of the second coating, the polymer has a mass percentage of 78% to 87.5%, the auxiliary binder has a mass percentage of 5% to 10%, the thickener has a mass percentage of 0.5% to 2%, and the wetting agent has a mass percentage of 7% to 10%, thereby obtaining a second coating with excellent adhesion.

In an embodiment of this application, an inorganic coating can be provided between the first coating and the separator substrate, or an inorganic coating can be provided between the first coating and the separator substrate and between the second coating and the separator substrate, or an inorganic coating can be provided between the second coating and the separator substrate. All of the above setting methods can further improve the mechanical strength of the separator.

In an embodiment of this application, the inorganic coating has a thickness of 0.5 μm to 6 μm. Without being limited to any theory, under a condition that the inorganic coating has an excessively small thickness, for example, less than 0.5 μm, the mechanical strength of the separator decreases, which is unfavorable to the enhancement of the cycling performance of the lithium-ion battery; and under a condition that the inorganic coating has an excessively large thickness, for example, greater than 6 μm, the separator becomes thicker as a whole, and the relative percentage of the electrode active material decreases, which is not conducive to improving the energy density of lithium-ion batteries. With the thickness of the inorganic coating controlled within the above range, both the cycling performance and the energy density of the lithium-ion battery can be improved.

This application does not particularly limit the material of the inorganic coating, as long as the purpose of this application can be achieved. For example, the inorganic coating may include at least one of boehmite, magnesium hydroxide, alumina, titanium dioxide, silicon dioxide, zirconium dioxide, tin dioxide, magnesium oxide, zinc oxide, barium sulfate, boron nitride, aluminum nitride, or silicon nitride. Moreover, this application does not particularly limit the method of preparing inorganic coating. For example, the inorganic coating may be formed by applying a slurry including the foregoing inorganic materials to the surface of the separator substrate.

In this application, a side of the separator having the first coating can be in contact with a positive electrode plate, and a side of the separator having a second coating can be in contact with a negative electrode plate, so that there is a good adhesion effect between the separator and both the positive electrode plate and the negative electrode plate, and there is better electrolyte penetration between the separator and the positive electrode plate, so as to improve the low-temperature cycling performance and fast-charging cycling performance of the lithium-ion battery. The separator of this application has lithium-ion permeability and electron barrier properties.

The positive electrode plate in this application is not particularly limited, as long as the purpose of this application can be realized. For example, the positive electrode plate typically includes a positive electrode current collector and a positive electrode active material layer. The positive electrode current collector is not particularly limited and may be any positive electrode current collector in the art, such as an aluminum foil, an aluminum alloy foil, or a composite current collector. The positive electrode active material layer includes a positive electrode active material, and the positive electrode active material is not particularly limited and can be any positive electrode active material in the art. For example, the positive electrode active material may include at least one of lithium nickel cobalt manganese oxide (811, 622, 523, 111), lithium nickel cobalt aluminate, lithium iron phosphate, lithium-rich manganese-based material, lithium cobaltate, lithium manganese oxide, lithium manganese ferro-manganese phosphate, or lithium titanate.

The negative electrode plate in this application is not particularly limited, as long as the purpose of this application can be realized. For example, the negative electrode plate typically includes a negative electrode current collector and a negative electrode active material layer. The negative electrode current collector is not particularly limited and may be any negative electrode current collector in the art, such as a copper foil, an aluminum foil, an aluminum alloy foil, and a composite current collector. The negative electrode active material layer includes a negative electrode active material, where the negative electrode active material is not particularly limited and may be any negative electrode active material in the art. For example, the negative electrode active material may include at least one of artificial graphite, natural graphite, intermediate phase carbon microspheres, soft carbon, hard carbon, silicon, silicon carbon, lithium titanate, and the like.

The lithium-ion battery in this application further includes an electrolyte. The electrolyte may be one or more of a gel electrolyte, a solid electrolyte, and a liquid electrolyte. The liquid electrolyte includes a lithium salt and a non-aqueous solvent.

In some embodiments of this application, the lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, LiPF₆ may be selected as the lithium salt because it can provide high ionic conductivity and improve the cycling performance.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is dimethyl carbonate (DMC), diethyl carbonate (DEC), dipropyl carbonate (DPC), methyl propyl carbonate (MPC), ethylene propyl carbonate (EPC), methyl ethyl carbonate (MEC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 4,5-difluoro-1,3-dioxolan-2-one, 4,4-difluoro-1,3-dioxolan-2-one, 4,4,5-trifluoro-1,3-dioxolan-2-one, 4,4,5,5-tetrafluoro-1,3-dioxolan-2-one, 4-fluoro-5-methyl-1,3-dioxolan-2-one, 4-fluoro-4-methyl-1,3-dioxolan-2-one, 4,5-difluoro-4-methyl-1,3-dioxolan-2-one, 4,4,5-trifluoro-5-methyl-1,3-dioxolan-2-one, 4-trifluoroMethyl ethylene carbonate, or a combination thereof.

An example of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl-sulfolane, 1,3-dimethyl-2-imidazolidinone, N-methyl-2-pyrrolidone, methylamide, dimethylformamide, acetonitrile, trimethyl phosphate, triethyl phosphate, trioctyl phosphate, phosphate ester, or a combination thereof.

This application also provides an electrochemical apparatus including a positive electrode plate, a negative electrode plate, and a separator, the separator being disposed between the positive electrode plate and the negative electrode plate, having good low-temperature performance.

This application further provides an electronic apparatus including the electrochemical apparatus described in the embodiments of this application, having good low-temperature performance.

The electronic apparatus of this application is not particularly limited and can be any electronic apparatus known in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, and a lithium-ion capacitor.

A process for preparing the electrochemical apparatus is well known to persons skilled in the art and is not particularly limited in this application. For example, the lithium-ion battery may be manufactured in the following process: The positive electrode and the negative electrode are stacked with the separator therebetween and are put into a housing after operations such as winding and folding as needed, an electrolyte is injected into the housing, and the housing is sealed. The separator used is the separator provided in this application. In addition, an overcurrent prevention element, a guide plate, and the like may be placed in the housing as needed, so as to prevent pressure increase, overcharge, and overdischarge in the lithium-ion battery.

The method for preparing polymer primary particles of this application is not particularly limited, and the preparation method commonly used by persons skilled in the art may be used. For example, the following preparation method may be used:

After the reaction vessel is evacuated and nitrogen gas is pumped to replace oxygen, deionized water, vinylidene fluoride (VDF), an emulsifier of perfluoroalkyl carboxylate salt, and a chain transfer agent of isopropanol are added to the reaction vessel in the stirrer until the pressure in the reaction vessel is about 3.5 MPa. Then, the temperature is raised to 50° C. to and the stirrer rotates at 70 r/min to 100 r/min to start polymerization reaction. In addition, vinylidene fluoride monomers are continuously added to the reaction vessel to maintain a pressure of 3.5 MPa until the solid percentage of the emulsion in the reaction vessel reaches 25% to 30% to stop the reaction. Then, unreacted monomers are recovered, and the polymer emulsion is released. After centrifugation, washing, and drying, polymer primary particles are obtained.

This application does not particularly limit the initiator, as long as it can initiate polymerization of monomers. For example, the initiator can be diisopropyl benzene peroxide. This application does not particularly limit the amount of the monomers, deionized water, initiator, and chain transfer agent added, as long as polymerization reactions of added monomers are ensured. For example, the deionized water is 5 to 10 times the mass of the monomers, the initiator accounts for 0.05% to 0.5% of the mass of the monomers, the emulsifier accounts for 0.1% to 1% of the mass of the monomers, and the chain transfer agent accounts for 3% to 7% of the mass of the monomers.

This application does not particularly limit the preparation method of auxiliary binder, and a preparation method commonly used by the persons skilled in the art may be used. The solution method, the slurry method, the vapor-phase method, and so on may be selected according to types of monomers used.

This application does not particularly limit the preparation method of secondary particles, and the preparation method commonly used by persons skilled in the art can be used. For example, the emulsion polymerization method may be first used to prepare primary particles, and then spray drying is performed on the slurry containing the primary particles to obtain secondary particles. Certainly, an existing polymerization method such as the emulsion polymerization method or the suspension polymerization method may be used to realize polymerization of primary particles, as long as the secondary particles can be obtained through the primary particles to achieve the inventive purpose of this application.

In this application, the term “Dv50” indicates a particle size at 50% cumulative volume distribution, where particles whose size is less than that particle size have a cumulative volume accounting for 50% of the total volume of all particles.

This application provides a separator and an electrochemical apparatus and electronic apparatus including such separator. As a first coating of the separator includes polymer secondary particles having a melting point of 130° C. to 150° C., the first coating has good adhesion and resistance to electrolyte swelling. In addition, the secondary particles have many internal voids, which facilitates electrolyte entry into the voids, thereby improving electrolyte penetration into the first coating. As a result, the lithium-ion battery has better low-temperature performance.

### BRIEF DESCRIPTION OF DRAWINGS

To describe the technical solutions in this application and the prior art more clearly, the following briefly describes the accompanying drawings required for describing the embodiments and the prior art. Apparently, the accompanying drawings in the following description show merely some embodiments of this application.

FIG. 1 is a schematic structural diagram of a separator according to a first embodiment of this application;

FIG. 2 is a schematic structural diagram of a separator according to a second embodiment of this application;

FIG. 3 is a schematic structural diagram of a separator according to a third embodiment of this application; and

FIG. 4 is a schematic structural diagram of a separator according to a fourth embodiment of this application.

### DETAILED DESCRIPTION

To make the objectives, technical solutions, and advantages of this application more comprehensible, the following describes this application in detail with reference to accompanying drawings and embodiments. Apparently, the described embodiments are merely some rather than all of the embodiments of this application.

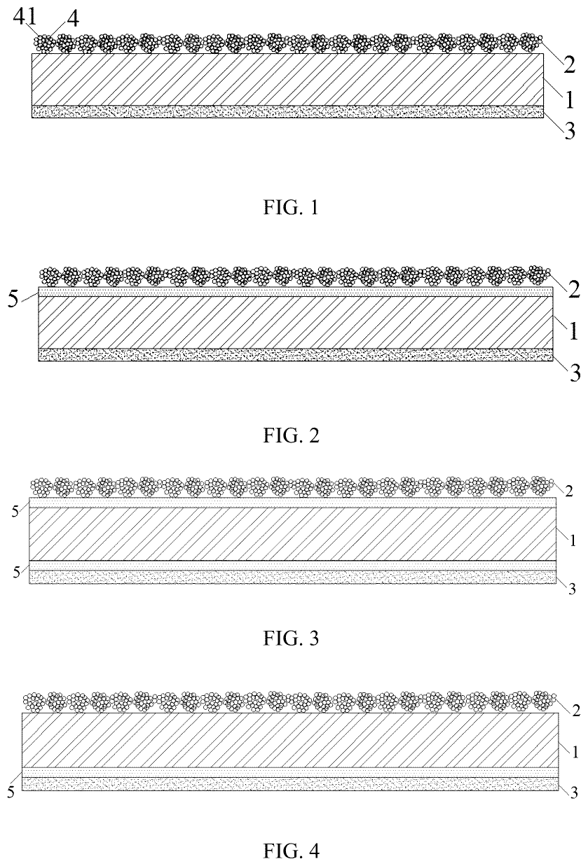

As shown in FIG. 1, a separator of this application includes a separator substrate 1, and a first coating 2 and a second coating 3 respectively provided on two surfaces of the separator substrate 1. The first coating 2 includes polymer secondary particles 4, and the secondary particles 4 are formed by aggregation of primary particles 41.

In an embodiment of this application, an inorganic coating 5 is provided between the first coating 2 and the separator substrate 1, as shown in FIG. 2.

In an embodiment of this application, as shown in FIG. 3, an inorganic coating 5 is provided between the first coating 2 and the separator substrate 1, and an inorganic coating 5 is also provided between the second coating 3 and the separator substrate 1.

In an embodiment of this application, an inorganic coating 5 is provided between the second coating 2 and the separator substrate 1, as shown in FIG. 4.

### EXAMPLES

The following describes the embodiments of this application more specifically by using examples and comparative examples. Various tests and evaluations were performed in the following methods. In addition, unless otherwise specified, “part” and “%” are based on weight.

Test Method and Device

Testing of Adhesion Between Separator and Electrode Plate:

Adhesion between the separator and the positive electrode plate or the negative electrode plate was tested according to the national standard GB/T 2790-1995, that is, the 180° peel test standard. The separator and the positive electrode plate or the negative electrode plate were cut into samples of 54.2 mm×72.5 mm, and the separator was laminated with the positive electrode plate or the negative electrode plate through hot pressing by a hot press machine in the following hot pressing conditions: at a temperature of 85° C. under a pressure of 1 Mpa for a hot pressing time of 85 s (seconds). Then, the laminated sample was cut into strips of to test the adhesion between the separator and the positive electrode plate or negative electrode plate according to the 180° peel test standard.

Low-Temperature Performance Testing:

Step 1: In a 25° C. environment, the lithium-ion battery after formation was subjected to first charge and discharge: constant-current and constant-voltage charging was performed at a charging current of 0.1C until the upper voltage limit reaches 4.45V, and the fully charged lithium-ion battery was left standing for 5 minutes.

Step 2: The lithium-ion battery was discharged to 3V at a rate of 0.2C, a discharge capacity of the first cycle was recorded, and then the lithium-ion battery was left standing for 5 minutes.

Step 4: The lithium-ion battery was charged to 4.45V at a constant current at a charging rate of 1.5C, charged to 0.02C at a constant voltage, and then left standing for 5 minutes.

Step 5: The furnace temperature was adjusted to {25, 10, 0, −10, −20, 45, 60}° C., then the lithium-ion battery was left standing for 5 minutes and discharged to 3V at a rate of 0.2C, and then the lithium-ion battery was left standing for 5 minutes.

Step 6: The furnace temperature was adjusted to 25° C. and then the lithium-ion battery was left standing for 60 minutes.

Step 7: Steps 4 to 6 above were repeated. After tests were sequentially performed according to the temperature conditions in step 5, the final discharge capacity of the lithium-ion battery under each temperature condition was recorded, and then a low-temperature capacity retention rate of the lithium-ion battery under the condition of −20° C. was calculated by using the final discharge capacity of the lithium-ion battery recorded under the condition of −20° C. according to the following expression:

Low-temperature capacity retention rate=(final discharge capacity of the lithium-ion battery at −20° C./discharge capacity of the first cycle of the lithium-ion battery at 25° C.)×100%.

Testing of Melting Point of Polymer Secondary Particles:

The general-purpose differential scanning calorimeter (DSC) method was used: 5 mg of samples of polymer secondary particles were taken and then heated up to 150° C. at a heating rate of 5° C./min, a DSC curve was collected, and the melting point of the polymer secondary particles was determined according to the obtained DSC curve.

Testing of Crystallinity of Polymer Secondary Particles:

A general-purpose differential scanning calorimeter (DSC) was used. A given amount (such as 5 mg) of samples of polymer secondary particles was heated up to 180° C. at a specified rate (such as 5° C./min), kept at the constant temperature for 2 min, and then cooled down to 80° C. at a specified rate (such as 5° C./min), and the crystallinity was determined using the DSC method according to the following formula:

Crystallinity=ΔHₘ/ΔHₘ⁰
where ΔHₘ and ΔHₘ⁰ are the heat of fusion of the sample and the heat of fusion of the fully crystallized sample, respectively.

Testing of Dv50 of Polymer Primary Particles and Polymer Secondary Particles:

The Dv50 of polymer primary particles and polymer secondary particles is tested using a laser particle size analyzer.

### EXAMPLES

The following describes the embodiments of this application more specifically by using examples and comparative examples. Various tests and evaluations were performed in the following methods. In addition, unless otherwise specified, “part” and “%” are based on weight.

### Example 1

<1-1. Preparation of Copolymer Secondary Particles>

<1-1-1. Preparation of Primary Particles>

After the reaction vessel was evacuated, nitrogen gas to replace oxygen, deionized water, vinylidene fluoride, an initiator of diisopropyl benzene peroxide, an emulsifier of perfluoroalkyl carboxylate salt, and a chain transfer agent of isopropanol were added to the reaction vessel until the pressure in the reaction vessel in the stirrer is 3.5 MPa, where the deionized water was 7 times the mass of the vinylidene fluoride monomer, the initiator accounted for 0.2% of the mass of the vinylidene fluoride monomer, the emulsifier accounted for 0.5% of the mass of the vinylidene fluoride monomer, and the chain transfer agent accounted for 5% of the mass of the vinylidene fluoride monomer. Then, the temperature was raised to 60° C., the stirrer rotated at a speed of 80 r/min to start polymerization reaction. In addition, vinylidene fluoride monomers were continuously added to the reaction vessel to maintain a pressure of 3.5 MPa until the solid percentage of the emulsion in the reaction vessel reached 25% to stop the reaction. Then, unreacted monomers were recovered, and the polymer emulsion was released. After centrifugation, washing, and drying, primary particles of polyvinylidene fluoride were obtained.

<1-1-2. Preparation of Secondary Particles>

The primary particles of polyvinylidene fluoride were dispersed into deionized water. Subsequently, the mixture was stirred using an MSK-SFM-10 vacuum stirrer for 120 minutes at a revolution speed of 40 rpm and a rotation speed of 1500 rpm, resulting in a primary particle slurry with a solid percentage of 10%.

The obtained primary particle slurry was then transferred to a centrifugal rotary nozzle of a spray drying granulator at a centrifugal speed of 2000 rpm, forming tiny droplets. The spray drying granulator operated at an inlet temperature of 110° C. and an outlet temperature of 100° C. After cooling, the powder was collected to yield polyvinylidene fluoride secondary particles. The obtained secondary particles had a melting point of 130° C., a Dv50 of 20 μm, and a sphericity of 0.8.

<1-2. Preparation of Positive Electrode Plate>

Lithium cobaltate, acetylene black, and polyvinylidene fluoride (PVDF) as positive electrode active materials were mixed in a mass ratio of 94:3:3, N-methylpyrrolidone (NMP) was added as a solvent, to prepare a slurry with a solid percentage of 75%, and the slurry was stirred uniformly. The slurry was uniformly applied on a surface of an aluminum foil with a thickness of 12 μm. After drying at 90° C. and cold pressing, a positive electrode plate with a 100 μm thick positive electrode active material layer was obtained. Then the foregoing steps were repeatedly performed on another surface of the positive electrode plate to obtain the positive electrode plate with both surfaces coated with the positive electrode active material layer. The positive electrode plate was cut into a size of 74 mm×867 mm and then welded with tabs for use.

<1-3. Preparation of Negative Electrode Plate>

Artificial graphite, acetylene black, styrene-butadiene rubber, and sodium carboxy methyl cellulose as negative electrode active materials were mixed in a mass ratio of 96:1:1.5:1.5, then deionized water was added as a solvent, to prepare a slurry with a solid percentage of 70%, and the slurry was stirred uniformly. The slurry was uniformly applied onto one surface of a copper foil with a thickness of 8 μm. The copper foil was dried at 110° C., followed by cold pressing to obtain a negative electrode plate with one surface coated with a negative electrode active material layer with a thickness of 150 μm. Then the foregoing coating steps were repeated on another surface of the negative electrode plate to obtain a negative electrode plate coated with negative electrode active material layers on two surfaces. The negative electrode plate was cut into dimensions of 74 mm×867 mm and then welded with tabs for later use.

<1-4. Preparation of Separator>

<1-4-1. Preparation of First Coating>

90 g of prepared polyvinylidene fluoride secondary particles was added. Then, 10 g of auxiliary binder acrylonitrile was added to a stirrer, and the mixture was stirred and mixed thoroughly. Subsequently, deionized water was introduced for stirring, and the slurry viscosity was adjusted to 100 mPa·s, resulting in a slurry A with a solid percentage of 12%. The slurry A was uniformly applied on one surface of the PE separator substrate, creating a first coating with a coating weight of 0.8 g/m², as indicated in Table 1. Subsequently, drying was completed in an oven. The separator substrate is PE material with a thickness of 5 μm.

<1-4-2. Preparation of Second Coating>

91 g of polymer binder with a non-core-shell structure (a copolymer polymerized from 80% styrene, 10% isobutyl acrylate, and 10% acrylonitrile by mass, with a Dv50 of 0.3 μm) was added in the stirrer, and then 0.5 g of sodium carboxymethylcellulose was added, and the mixture was stirred and mixed thoroughly; next, 8.5 g of a wetting agent, dimethicone, was added, and then deionized water was added for stirring, resulting in a slurry B with a viscosity of 40 MPa·s and a solid percentage of 5%. The above slurry B was uniformly applied on another surface of the PE separator substrate, creating a second coating with a coating weight of 0.5 g/m². Subsequently, drying was completed in an oven.

<1-5. Preparation of Electrolyte>

In an environment with a water content less than 10 ppm, non-aqueous organic solvents of ethylene carbonate (EC), diethyl carbonate (DEC), propylene carbonate (PC), propyl propionate (PP), and vinylene carbonate (VC) were mixed in a mass ratio of and then lithium hexafluorophosphate (LiPF6) was added to the non-aqueous organic solvents, dissolved and mixed uniformly to obtain an electrolyte. A mass ratio of LiPF6 to the non-aqueous organic solvent was 8:92.

<1-6 Preparation of Lithium-Ion Battery>

The positive electrode plate, the separator, and the negative electrode plate prepared above were stacked in order, so that a surface of the separator with the first coating was in contact with the positive electrode plate and a surface of the separator with the second coating was in contact with the negative electrode plate. Then, the stacked layers were wound to obtain an electrode assembly. The electrode assembly was put into an aluminum-plastic film packaging bag and was dehydrated at 80° C., and the prepared electrolyte was injected. Then, after processes including vacuum packaging, standing, formation, and shaping, a lithium-ion battery was obtained.

### Example 2

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 3

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 4

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 5

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 6

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 7

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 8

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 9

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 10

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 11

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 12

The polyvinylidene fluoride secondary particles were prepared using a method similar to the (1-1) preparation of copolymer secondary particles in example 1. The melting point, Dv50, sphericity, and crystallinity thereof were shown in Table 1.

### Example 13

The polyvinylidene fluoride secondary particles were prepared using a method similar to the (1-1) preparation of copolymer secondary particles in example 1. The melting point, Dv50, sphericity, and crystallinity thereof were shown in Table 1, and the coating weight of the first coating was shown in Table 1.

### Example 14

The polyvinylidene fluoride secondary particles were prepared using a method similar to the (1-1) preparation of copolymer secondary particles in example 1. The melting point, Dv50, sphericity, and crystallinity thereof were shown in Table 1, and the coating weight of the first coating was shown in Table 1.

### Example 15

The polyvinylidene fluoride secondary particles were prepared using a method similar to the (1-1) preparation of copolymer secondary particles in example 1. The melting point, Dv50, sphericity, and crystallinity thereof were shown in Table 1, and the coating weight of the first coating was shown in Table 1.

### Example 16

The polyvinylidene fluoride secondary particles were prepared using a method similar to the (1-1) preparation of copolymer secondary particles in example 1. The melting point, Dv50, sphericity, and crystallinity thereof were shown in Table 1, and the coating weight of the first coating was shown in Table 1.

### Example 17

The polyvinylidene fluoride secondary particles were prepared using a method similar to the (1-1) preparation of copolymer secondary particles in example 1. The Dv50, sphericity, and crystallinity thereof were shown in Table 2.

### Example 18

The polyvinylidene fluoride secondary particles were prepared using a method similar to the (1-1) preparation of copolymer secondary particles in example 1. The Dv50, sphericity, and crystallinity thereof were shown in Table 2.

### Example 19

The method was the same as example 1 except that the coating weight of the second coating was adjusted to 0.1 g/m² in the (1-4-2) preparation of second coating. Adhesion between the separator and the negative electrode plate was shown in Table 3.

### Example 20

The method was the same as example 1 except that the coating weight of the second coating was adjusted to 1.0 g/m² in the (1-4-2) preparation of second coating. Adhesion between the separator and the negative electrode plate was shown in Table 3.

### Example 21

The method was the same as example 3 except that in the (1-6) preparation of lithium-ion battery, the surface of the separator having a first coating was in contact with the negative electrode plate, and the surface of the separator having a second coating was in contact with the positive electrode plate. Adhesion between the separator and the positive electrode plate, as well as the negative electrode plate was shown in Table 4.

### Example 22

The method was the same as example 3 except that the polyvinylidene fluoride secondary particles of the first coating in example 3 were replaced with copolymer secondary particles formed from 95% vinylidene fluoride and 5% hexafluoropropylene by mass.

### Example 23

The method was the same as example 3 except that the polyvinylidene fluoride secondary particles of the first coating in example 3 were replaced with copolymer secondary particles formed from 85% styrene, 10% butadiene, and 5% acrylic acid by mass.

### Example 24

The method was the same as example 3 except that the polyvinylidene fluoride secondary particles of the first coating in example 3 were replaced with copolymer secondary particles formed from 75% styrene and 25% acrylate by mass.

### Example 25

The method was the same as example 3 except that the polyvinylidene fluoride secondary particles of the first coating in example 3 were replaced with copolymer secondary particles formed from 50% acrylic acid, 25% acrylonitrile, and 25% styrene by mass.

### Example 26

The method was the same as example 3 except that in the (1-4) preparation of separator, an inorganic coating was provided between the first coating and the separator substrate, as shown in FIG. 2. The thickness of the inorganic coating was 2 μm.

<Preparation of Inorganic Coating>

Inorganic particles of boehmite with a Dv50 of 1 μm were mixed with polyacrylate in a mass ratio of 90:10. The mixture was then dissolved into deionized water to create an inorganic coating slurry with a solid percentage of 50%. This resulting inorganic coating slurry was uniformly applied to one surface of the separator substrate using a micro-concave coating method, producing a heat-resistant layer. Subsequently, drying was completed in an oven. Next, the first coating was then prepared on the surface of the inorganic coating by following <preparation of first coating> in example 1.

### Example 27

The method was the same as example 3 except that in the (1-4) preparation of separator, an inorganic coating was provided between the first coating and the separator substrate and between the second coating and the separator substrate, as shown in FIG. 3. The thickness of the inorganic coating was 2 μm.

### Example 28

The method was the same as example 3 except that in the (1-4) preparation of separator, an inorganic coating was provided between the second coating and the separator substrate, as shown in FIG. 4. The thickness of the inorganic coating was 2 μm.

### Comparative Example 1

The polyvinylidene fluoride secondary particles were prepared using a method similar to the (1-1) preparation of copolymer secondary particles in example 1, with only the melting point adjusted to 125° C. and the crystallinity adjusted to 34, the remaining being the same as in example 3.

### Comparative Example 2

The polyvinylidene fluoride secondary particles were prepared using a method similar to the (1-1) preparation of copolymer secondary particles in example 1, with only the melting point adjusted to 155° C. and the crystallinity adjusted to 50, the remaining being the same as in example 3.

### Comparative Example 3

The polyvinylidene fluoride secondary particles were prepared using a method similar to the (1-1) preparation of copolymer secondary particles in example 1, with only the Dv50 adjusted to 5 μm, the remaining being the same as in example 3.

### Comparative Example 4

The polyvinylidene fluoride secondary particles were prepared using a method similar to the (1-1) preparation of copolymer secondary particles in example 1, with only the Dv50 adjusted to 35 μm, the remaining being the same as in example 3.

### Comparative Example 5

The polyvinylidene fluoride secondary particles were prepared using a method similar to the (1-1) preparation of copolymer secondary particles in example 1, with only the sphericity adjusted to 0.5, the remaining being the same as in example 3.

### Comparative Example 6

The method was the same as example 3 except that the coating weight of the first coating was adjusted to 0.3 g/m² in the (1-4) preparation of separator.

### Comparative Example 7

The method was the same as example 3 except that the coating weight of the first coating was adjusted to 1.1 g/m² in the (1-4) preparation of separator.

### Comparative Example 8

The method was the same as example 3 except that the first coating was replaced with a second coating in the (1-4) preparation of separator, that is, both surfaces of the separator were coated with the second coating.

Preparation parameters and test results of each example and comparative example are shown in Tables 1 to 6 below:

TABLE 1
Preparation parameters and test results of examples 1 to 16 and comparative examples 1 to 8

| | | | | | | | Adhesion | |
|---|---|---|---|---|---|---|---|---|
| | | | | | | | between | |
| | | | | | | | separator | |
| | | Melting | | | Crystallinity | Coating | and | Capacity |
| | | point of | Dv50 of | | of | weight of | positive | retention rate |
| | Material of | secondary | secondary | Sphericity of | secondary | first | electrode | at low |
| | secondary | particles | particles | secondary | particles | coating | plate | temperature |
| | particles | (° C.) | (μm) | particles | (%) | (g/m²) | (N/m) | (−20° C., %) |
| Example 1 | Polyvinylidene | 130 | 20 | 0.8 | 39 | 0.8 | 20.2 | 86.7 |
| | fluoride | | | | | | | |
| Example 2 | Polyvinylidene | 135 | 20 | 0.8 | 40 | 0.8 | 19.6 | 87.3 |
| | fluoride | | | | | | | |
| Example 3 | Polyvinylidene | 140 | 20 | 0.8 | 42 | 0.8 | 18.9 | 88.5 |
| | fluoride | | | | | | | |
| Example 4 | Polyvinylidene | 145 | 20 | 0.8 | 44 | 0.8 | 17.5 | 88.3 |
| | fluoride | | | | | | | |
| Example 5 | Polyvinylidene | 150 | 20 | 0.8 | 45 | 0.8 | 15.8 | 88.5 |
| | fluoride | | | | | | | |
| Example 6 | Polyvinylidene | 140 | 10 | 0.8 | 42 | 0.8 | 21.1 | 85.3 |
| | fluoride | | | | | | | |
| Example 7 | Polyvinylidene | 140 | 15 | 0.8 | 42 | 0.8 | 19.8 | 86.6 |
| | fluoride | | | | | | | |
| Example 8 | Polyvinylidene | 140 | 25 | 0.8 | 42 | 0.8 | 16.8 | 88.9 |
| | fluoride | | | | | | | |
| Example 9 | Polyvinylidene | 140 | 30 | 0.8 | 42 | 0.8 | 15.7 | 89.2 |
| | fluoride | | | | | | | |
| Example 10 | Polyvinylidene | 140 | 20 | 0.7 | 42 | 0.8 | 20.3 | 87.1 |
| | fluoride | | | | | | | |
| Example 11 | Polyvinylidene | 140 | 20 | 0.9 | 42 | 0.8 | 18.3 | 89.2 |
| | fluoride | | | | | | | |
| Example 12 | Polyvinylidene | 140 | 20 | 1.0 | 42 | 0.8 | 17.2 | 89.9 |
| | fluoride | | | | | | | |
| Example 13 | Polyvinylidene | 140 | 20 | 0.8 | 42 | 0.4 | 9.3 | 90.6 |
| | fluoride | | | | | | | |
| Example 14 | Polyvinylidene | 140 | 20 | 0.8 | 42 | 0.6 | 14.1 | 89.3 |
| | fluoride | | | | | | | |
| Example 15 | Polyvinylidene | 140 | 20 | 0.8 | 42 | 0.9 | 21.1 | 87.1 |
| | fluoride | | | | | | | |
| Example 16 | Polyvinylidene | 140 | 20 | 0.8 | 42 | 1.0 | 22.4 | 86.4 |
| | fluoride | | | | | | | |
| Comparative | Polyvinylidene | 125 | 20 | 0.8 | 34 | 0.8 | 21.3 | 84.4 |
| example 1 | fluoride | | | | | | | |
| Comparative | Polyvinylidene | 155 | 20 | 0.8 | 50 | 0.8 | 14.3 | 87.6 |
| example 2 | fluoride | | | | | | | |
| Comparative | Polyvinylidene | 140 | 5 | 0.8 | 42 | 0.8 | 22.4 | 84.2 |
| example 3 | fluoride | | | | | | | |
| Comparative | Polyvinylidene | 140 | 35 | 0.8 | 42 | 0.8 | 14.3 | 87.5 |
| example 4 | fluoride | | | | | | | |
| Comparative | Polyvinylidene | 140 | 20 | 0.5 | 42 | 0.8 | 21.1 | 84.1 |
| example 5 | fluoride | | | | | | | |
| Comparative | Polyvinylidene | 140 | 20 | 0.8 | 42 | 0.3 | 7.1 | 86.5 |
| example 6 | fluoride | | | | | | | |
| Comparative | Polyvinylidene | 140 | 20 | 0.8 | 42 | 1.1 | 23.6 | 84.1 |
| example 7 | fluoride | | | | | | | |
| Comparative | — | — | — | — | — | — | 19.2 | 86.1 |
| example 8 | | | | | | | | |

TABLE 2
Preparation parameters and test results of examples 3, 17, and18

| | | | | | | Adhesion | |
|---|---|---|---|---|---|---|---|
| | | | | | | between | |
| | | | | Crystallinity | Coating | separator | Capacity |
| | | Dv50 of | Sphericity | of | weight of | and | retention rate |
| | Material of | secondary | of | secondary | first | positive | at low |
| | secondary | particles | secondary | particles | coating | electrode | temperature |
| | particles | (μm) | particles | (%) | (g/m²) | plate (N/m) | (−20° C., %) |
| Example 3 | Polyvinylidene | 20 | 0.8 | 42 | 0.8 | 18.9 | 88.5 |
| | fluoride | | | | | | |
| Example 17 | Polyvinylidene | 20 | 0.8 | 38 | 0.8 | 19.5 | 87.4 |
| | fluoride | | | | | | |
| Example 18 | Polyvinylidene | 20 | 0.8 | 46 | 0.8 | 17.6 | 89.4 |
| | fluoride | | | | | | |

TABLE 3
Preparation parameters and test results of examples 3, 19, and 20

| | | | | | | | Adhesion | |
|---|---|---|---|---|---|---|---|---|
| | | | | | | | between | |
| | | | | | | | separator | Capacity |
| | | Melting | | | Crystallinity | Coating | and | retention |
| | | point of | Dv50 of | | of | weight of | negative | rate |
| | Material of | secondary | secondary | Sphericity of | secondary | second | electrode | at low |
| | secondary | particles | particles | secondary | particles | coating | plate | temperature |
| | particles | (° C.) | (μm) | particles | (%) | (g/m²) | (N/m) | (−20° C., %) |
| Example 3 | Polyvinylidene | 140 | 20 | 0.8 | 42 | 0.5 | 19.1 | 88.5 |
| | fluoride | | | | | | | |
| Example 19 | Polyvinylidene | 140 | 20 | 0.8 | 42 | 0.1 | 9.5 | 88.7 |
| | fluoride | | | | | | | |
| Example 20 | Polyvinylidene | 140 | 20 | 0.8 | 42 | 1.0 | 19.6 | 88.2 |
| | fluoride | | | | | | | |

TABLE 4
Preparation parameters and test results of examples 3 and 21

| | | | | | | Adhesion | Adhesion | |
|---|---|---|---|---|---|---|---|---|
| | | | | | | between | between | |
| | | | | | | separator | separator | Capacity |
| | | Melting | | | Crystallinity | and | and | retention |
| | | point of | Dv50 of | | of | positive | negative | rate |
| | Material of | secondary | secondary | Sphericity | secondary | electrode | electrode | at low |
| | secondary | particles | particles | of secondary | particles | plate | plate | temperature |
| | particles | (° C.) | (μm) | particles | (%) | (N/m) | (N/m) | (−20° C., %) |
| Example 3 | Polyvinylidene | 140 | 20 | 0.8 | 42 | 18.9 | 19.1 | 88.5 |
| | fluoride | | | | | | | |
| Example 21 | Polyvinylidene | 140 | 20 | 0.8 | 42 | 19.2 | 18.7 | 88.3 |
| | fluoride | | | | | | | |

TABLE 5
Preparation parameters and test results of examples 22 to 25

| | | | | | | | Adhesion | |
|---|---|---|---|---|---|---|---|---|
| | | | | | | | between | |
| | | | | | | Coating | separator | Capacity |
| | | Melting | | | Crystallinity | weight | and | retention |
| | | point of | Dv50 of | | of | of | positive | rate |
| | Material of | secondary | secondary | Sphericity | secondary | second | electrode | at low |
| | secondary | particles | particles | of secondary | particles | coating | plate | temperature |
| | particles | (° C.) | (μm) | particles | (%) | (g/m²) | (N/m) | (−20° C., %) |
| Example 22 | 95% vinylidene | 140 | 20 | 0.8 | 42 | 0.5 | 18.4 | 88.1 |
| | fluoride, 5% | | | | | | | |
| | hexafluoropropylene | | | | | | | |
| Example 23 | 85% styrene, | 140 | 20 | 0.8 | 42 | 0.5 | 18.1 | 87.7 |
| | 10% butadiene, | | | | | | | |
| | 5% acrylic acid | | | | | | | |
| Example 24 | 75% styrene, | 140 | 20 | 0.8 | 42 | 0.5 | 18.8 | 87.5 |
| | 25% acrylate | | | | | | | |
| Example 25 | 50% acrylic acid, | 140 | 20 | 0.8 | 42 | 0.5 | 17.9 | 88.5 |
| | 25% acrylonitrile, | | | | | | | |
| | 25% styrene | | | | | | | |

TABLE 6
Preparation parameters and test results of examples 26 to 28

| | | | | | | Adhesion | |
|---|---|---|---|---|---|---|---|
| | | | | | | between | |
| | | | | | | separator | Capacity |
| | | | | Crystallinity | Coating | and | retention |
| | | Dv50 of | | of | weight of | positive | rate |
| | Material of | secondary | Sphericity | secondary | first | electrode | at low |
| | secondary | particles | of secondary | particles | coating | plate | temperature |
| | particles | (μm) | particles | (%) | (g/m²) | (N/m) | (−20° C., %) |
| Example 26 | Polyvinylidene | 20 | 0.8 | 42 | 0.8 | 19.1 | 88.1 |
| | fluoride | | | | | | |
| Example 27 | Polyvinylidene | 20 | 0.8 | 42 | 0.8 | 19.0 | 87.3 |
| | fluoride | | | | | | |
| Example 28 | Polyvinylidene | 20 | 0.8 | 42 | 0.8 | 18.8 | 87.1 |
| | fluoride | | | | | | |

It can be seen from examples 1 to 5 and comparative examples 1 and 2 in Table 1 that with the increase of the melting point of the secondary particles, the adhesion between the separator and the positive electrode plate decreases, and the low-temperature capacity retention rate of the lithium-ion battery generally increases. However, under a condition that the secondary particles have an excessively low melting point (for example, in comparative example 1), the low-temperature capacity retention rate of the lithium-ion battery is affected; and under a condition that the secondary particles have an excessively high melting point (for example, in comparative example 1), the adhesion between the separator and the electrode plate is affected.

It can be seen from examples 6 to 9 and comparative examples 3 and 4 in Table 1 that as the Dv50 of the secondary particles increases, the adhesion between the separator and the positive electrode plate decreases, and the low-temperature capacity retention rate of the lithium-ion battery increases. However, under a condition that the secondary particles have an excessively low Dv50 (for example, in comparative example 3), the low-temperature capacity retention rate of the lithium-ion battery is affected; and under a condition that the secondary particles have an excessively large Dv50 (for example, in comparative example 4), the adhesion between the separator and the electrode plate is affected.

It can be seen from examples 10 to 12 and comparative example 5 in Table 1 that as the sphericity of the secondary particles increases, the adhesion between the separator and the positive electrode plate decreases, and the low-temperature capacity retention rate of the lithium-ion battery increases. However, under a condition that the secondary particles have an excessively low sphericity (for example, in comparative example 5), the low-temperature capacity retention rate of the lithium-ion battery is affected.

It can be seen from examples 13 to 16 and comparative examples 6 and 7 in Table 1 that as the coating weight of the first coating increases, the adhesion between the separator and the positive electrode plate increases, and the low-temperature capacity retention rate of the lithium-ion battery decreases; and under a condition that the first coating has an excessively low coating weight (for example, in comparative example 6), the adhesion between the separator and the electrode plate is affected; and under a condition that the first coating has an excessively large coating weight (for example, in comparative example 7), the low-temperature capacity retention rate of the lithium-ion battery is affected. This may be because an increase in the coating weight of the first coating can improve the interfacial adhesion but results in a decrease in the relative percentage of the electrode active material.

It can be seen from example 3 and comparative example 8 in Table 1 that under a condition that both surfaces of the separator are coated with the second coating, the low-temperature capacity retention rate is affected although there is a high adhesion between the separator and the positive electrode plate.

It can be seen from examples 3, 17, and 18, and comparative examples 1 and 2 in Table 2 that as the crystallinity of the secondary particles increases, the adhesion between the separator and the positive electrode plate decreases, and the low-temperature capacity retention rate of the lithium-ion battery generally increases. However, under a condition that the secondary particles have an excessively low crystallinity (for example, in comparative example 1), the low-temperature capacity retention rate of the lithium-ion battery is affected; and under a condition that the secondary particles have an excessively high crystallinity (for example, in comparative example 2), the adhesion between the separator and the electrode plate is affected.

It can be seen from examples 3, 19, and 20 in Table 3 that the adhesion between the separator and the negative electrode plate increases as the coating weight of the second coating increases, indicating that the second coating of this application can also enhance the interfacial adhesion, but improves little the low-temperature capacity retention rate of the lithium-ion battery, which may be related to electrolyte penetration into the second coating.

It can be seen from examples 3 and 21 in Table 4 that the interfacial adhesion and the low-temperature capacity retention rate of the lithium-ion battery did not change much after switching the contact surfaces between the separator and the positive and negative electrode plates, indicating that the first coating of this application has good adhesion for both the positive electrode plate and negative electrode plate, as well as good electrolyte penetration.

It can be seen from examples 22 to 25 in Table 5 that although polymer secondary particles used for the first coating are different, the adhesion between the first coating and the electrode plates is nearly equal, and therefore the low-temperature capacity retention rate of the prepared lithium-ion batteries was similar.

It can be seen from examples 26 to 28 in Table 6 that the inorganic coating does not affect the interfacial adhesion and the low-temperature capacity retention rate of the lithium-ion battery to a significant extent. However, providing the inorganic coating can improve the mechanical strength of the separator.

In summary, the separator having the first coating and the second coating of this application is capable of effectively improving the adhesion between the separator and the electrode plate, as well as obtaining the low-temperature performance of the battery.

The foregoing descriptions are merely preferable embodiments of this application but are not intended to limit this application. Any modification, equivalent replacement, or improvement made without departing from the spirit and principle of this application shall fall within the protection scope of this application.

1. A separator comprising: a separator substrate; and a first coating and a second coating respectively provided on two surfaces of the separator substrate;
wherein the first coating comprises polymer secondary particles, and a melting point of the secondary particles is 130° C. to 150° C.

2. The separator according to claim 1, wherein the first coating satisfies at least one of the following conditions:
(a) a Dv50 of primary particles forming the secondary particles is 50 nm to 1000 nm;
(b) a Dv50 of the secondary particles is 10 μm to 30 μm;
(c) a sphericity of the secondary particles is 0.7 to 1; or
(d) a crystallinity of the secondary particles is 38% to 46%.

3. The separator according to claim 1, wherein a coating weight of the first coating is 0.4 g/m² to 1.0 g/m²; and a coating weight of the second coating is 0.1 g/m² to 1 g/m².

4. The separator according to claim 1, wherein a thickness of the first coating is 5 μm to 20 μm; and a thickness of the second coating is 0.2 μm to 4 μm.

5. The separator according to claim 1, wherein the first coating further comprises an auxiliary binder, and a mass of the auxiliary binder accounts for 5 wt % to 15 wt % of a total mass of the first coating.

6. The separator according to claim 1, wherein the secondary particles comprise at least one of homopolymers or copolymers of vinylidene fluoride, hexafluoropropylene, ethylene, propylene, vinyl chloride, chloropropylene, acrylic acid, acrylate, styrene, butadiene, or acrylonitrile.

7. The separator according to claim 1, wherein the second coating comprises a high molecular polymer with a core-shell structure, the core of the high molecular polymer with a core-shell structure being selected from at least one of homopolymers or copolymers of ethyl acrylate, butyl acrylate, ethyl methacrylate, styrene, chlorostyrene, fluorostyrene, methylstyrene, acrylic acid, methacrylic acid, or maleic acid; and the shell of the high molecular polymer with a core-shell structure is selected from at least one of homopolymers or copolymers of methyl acrylate, ethyl acrylate, butyl acrylate, methyl methacrylate, ethyl methacrylate, butyl methacrylate, ethylene, chlorostyrene, fluorostyrene, methyl styrene, acrylonitrile, or methacrylonitrile.

8. The separator according to claim 1, wherein the second coating comprises a high molecular polymer with a non-core-shell structure, the high molecular polymer with a non-core-shell structure being selected from at least one of homopolymers or copolymers of acrylic acid, acrylate, butadiene, styrene, acrylonitrile, ethylene, chlorostyrene, fluorostyrene, or propylene.

9. The separator according to claim 1, wherein an inorganic coating is further provided between the first coating and the separator substrate and/or between the second coating and the separator substrate; a thickness of the inorganic coating is 0.5 μm to 6 μm.

10. The separator according to claim 9, wherein the inorganic coating comprises at least one of boehmite, magnesium hydroxide, alumina, titanium dioxide, silicon dioxide, zirconium dioxide, tin dioxide, magnesium oxide, zinc oxide, barium sulfate, boron nitride, aluminum nitride, or silicon nitride.

11. An electrochemical apparatus comprising: a separator; the separator comprising a separator substrate, and a first coating and a second coating respectively provided on two surfaces of the separator substrate;
wherein the first coating comprises polymer secondary particles, and a melting point of the secondary particles is 130° C. to 150° C.

12. The electrochemical apparatus according to claim 11, wherein the first coating satisfies at least one of the following conditions:
(a) a Dv50 of primary particles forming the secondary particles is 50 nm to 1000 nm;
(b) a Dv50 of the secondary particles is 10 μm to 30 μm;
(c) a sphericity of the secondary particles is 0.7 to 1; or
(d) a crystallinity of the secondary particles is 38% to 46%.

13. The electrochemical apparatus according to claim 11, wherein a coating weight of the first coating is 0.4 g/m² to 1.0 g/m²; and a coating weight of the second coating is 0.1 g/m² to 1 g/m².

14. The electrochemical apparatus according to claim 11, wherein a thickness of the first coating is 5 μm to 20 μm; and a thickness of the second coating is 0.2 μm to 4 μm.

15. The electrochemical apparatus according to claim 11, wherein the first coating further comprises an auxiliary binder, and a mass of the auxiliary binder accounts for 5 wt % to 15 wt % of a total mass of the first coating.

16. The electrochemical apparatus according to claim 11, wherein the secondary particles comprise at least one of homopolymers or copolymers of vinylidene fluoride, hexafluoropropylene, ethylene, propylene, vinyl chloride, chloropropylene, acrylic acid, acrylate, styrene, butadiene, or acrylonitrile.

17. The electrochemical apparatus according to claim 11, wherein the second coating comprises a high molecular polymer with a core-shell structure, the core of the high molecular polymer with a core-shell structure being selected from at least one of homopolymers or copolymers of ethyl acrylate, butyl acrylate, ethyl methacrylate, styrene, chlorostyrene, fluorostyrene, methylstyrene, acrylic acid, methacrylic acid, or maleic acid; and the shell of the high molecular polymer with a core-shell structure is selected from at least one of homopolymers or copolymers of methyl acrylate, ethyl acrylate, butyl acrylate, methyl methacrylate, ethyl methacrylate, butyl methacrylate, ethylene, chlorostyrene, fluorostyrene, methyl styrene, acrylonitrile, or methacrylonitrile.

18. The electrochemical apparatus according to claim 11, wherein the second coating comprises a high molecular polymer with a non-core-shell structure, the high molecular polymer with a non-core-shell structure being selected from at least one of homopolymers or copolymers of acrylic acid, acrylate, butadiene, styrene, acrylonitrile, ethylene, chlorostyrene, fluorostyrene, or propylene.

19. The electrochemical apparatus according to claim 11, wherein an inorganic coating is further provided between the first coating and the separator substrate and/or between the second coating and the separator substrate, a thickness of the inorganic coating is 0.5 μm to 6 μm.

20. An electronic apparatus comprising the electrochemical apparatus according to claim 11.
